(19) United States
(12) Patent Application Publication
(10) Pub. No.: US 2006/0286993 A1
(43) Pub. Date: Dec. 21, 2006

(54) THROTTLING SERVER COMMUNICATIONS IN A COMMUNICATION NETWORK

(75) Inventors: Qiaobing Xie, South Barrington, IL (US); Bonnie Chen, Dallas, TX (US); Thomas G. Hallin, Erie, CO (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/424,018

(22) Filed: Jun. 14, 2006

Related U.S. Application Data
(60) Provisional application No. 60/692,507, filed on Jun. 20, 2005.

(51) Int. Cl. H04B 7/00

(52) U.S. Cl. 455/518

(57) ABSTRACT

An apparatus and method for throttling server communications in a communication network. Firstly, priorities are defined by a watcher for particular status events. These priorities are then mapped to a list of status events in an event filter. In response to a change of status event of a presentity, the status event is compared to the list of status events of the event filter. If the comparable status event has an associated higher priority, a notification is sent of the change of status event to the watcher with substantially no delay. If the comparable status notification event has an associated lower priority, the status event is filtered in the event filter, and sent to the watcher, as needed, during a predetermined interval. A unique priority code can be defined for events and/or a maximum delay for sending a notification of an event change can be defined for events.

### FIELD OF THE INVENTION

The present invention relates generally to cellular communication systems, and, in particular, to facilitate of Push-To-Talk communication services in a cellular communication system.

### BACKGROUND OF THE INVENTION

Recently, work has been proceeding in the implementation of Push-To-Talk (PTT) capabilities over Cellular communication (PoC) networks, such as Third Generation Partnership Project (3GPP) and 3GPP2 mobile packet data networks (e.g. Code Division Multiple Access (CDMA) communications systems or cdma2000 communication system). It is desired that such PoC system performs similarly to dispatch services presently available in other communication systems, such as two-way radio systems or iDEN™ communication systems. Traditional dispatch services typically allow for instant access by a mobile station originating a call to a target mobile station. For example, a dispatch group call service enables a user to communicate with a group of people simultaneously and instantaneously, typically by depressing a Push-To-Talk (PTT) key. Using a cellular system, such a call could not occur instantaneously since either telephone numbers would need to be dialed for a three-way call or arrangements would need to be made to setup a conference call. A dispatch point-to-point call service enables a user to communicate with another user quickly and spontaneously, again typically by depressing a PTT key. This feature is ideal for two people who are working together but are unable to speak with one another directly such as two people working in concert but in different parts of a building. Where a wireless telephone call may be more appropriate for a conversation, short messages between two people as they work are better facilitated by the dispatch point-to-point call service.

Low delay is a critical factor in any PTT call. For example, setup delay that is acceptable for a typical interconnect voice call can be unacceptable for PoC services which rely on a very fast connection being made to the called party. Accordingly, dispatch services provide an instant access call setup. However, a problem in implementing a dispatch system in a cellular communication system is that the average time that it takes a user to navigate a phone book appearing on a display screen of a cellular phone, select an entry, and then set up a PTT phone call is anything but instantaneous.

In the proposals for implementation of dispatch in a 3GPP or 3GPP2 packet data system, it typically takes approximately 3-4 seconds to initiate a PTT phone call by a user of an originating cellular phone, that is, to depress a PTT key after getting to the cellular phone's phone book. Upon the user selecting an entry and depressing the PTT key, the cellular phone conveys a call origination message to the infrastructure identifying one or more cellular phones or a talk group associated with the selected entry. In response to receiving the call origination message, the infrastructure conveys a paging message to the one or more identified cellular phones or to one or more cellular phones associated with the identified talk group. In response to receiving the page, each called cellular phone wakes up and conveys a page response back to the infrastructure. A PTT phone call is then set up. This process of waking up a called cellular phone and establishing a PTT phone call may take another 3-4 seconds. In addition, the user of the originating cellular phone is not permitted to speak until receiving a Talk Permit Tone (TPT), which is not conveyed to the user until traffic channels are established between the infrastructure and the one or more called cellular phones. As a result, 9-10 seconds may expire between a time that the user of the originating cellular phone determines to initiate a PTT phone call and a time that the user is permitted to speak.

A key feature in PoC service is knowing a location of a mobile device. A location, or “presence” is a virtual or real place where the mobile or server can be addressed and is usually associated with either documents or hosts. For documents, Uniform Resource Locators (URL) provide the addresses to HyperText Markup Language (HTML) or text documents which can be used as locations to open the document. Once opened, the document is considered to be “present”. For hosts, being logged into the host could qualify as being “present”, where the associated location is an Internet Protocol (IP) address that could be augmented with a port number.

Presence information can be disseminated through messaging services, such as the Multimedia Messaging Service (MMS) and is also supported by Session Initiated Protocol (SIP) signaling. SIP for Instant Messaging and Presence Leveraging Extensions (SIMPLE) builds upon the Session Initiation Protocol (SIP), used for multimedia communication signaling over IP networks, adding presence and instant messaging (IM) functionality. This presence service is presently being standardized in the Open Mobile Alliance (OMA), 3GPP and 3GPP2, and the Internet Engineering Task Force (IETF).

Associated with Presence information are entities such as a “presentity”, a “watcher”, and a “location”, which have been promulgated by the Internet Engineering Task Force (IETF) to describe a wide range of distributed application scenarios requiring presence awareness. Presence provides location, identity, and activity information. A presentity is a uniquely identified entity that is present at a location having, for example, a “user domain” identifier. A presentity can be a mobile device (i.e. user equipment) or a host (i.e. a server, web page, or device or application at a particular address) and can be a running application or a user agent. A presentity has presence information associated with it, such as its location and current state. The current state of a presentity may be represented by, for example, states such as: “online”; “busy”; “idle”; “reading”; or “locked”; but being present does not necessarily mean that the presentity is available.

A watcher looks for the presence information of others. Prior art methods for watchers to obtain presence information include fetching presence information, periodically polling for presence information; or subscribing to the presence information of another. Watchers may also be presentities, such as would be the case when mobile devices are interested in each other's presence. Presence information can be automatically established by distribution through an MMS architecture, whereby the presence information can be accessed automatically by each Multimedia Message Service Center (MMSC), to deliver presence information in forward or reverse MMS messaging sequences.

A problem arises in the amount of presence information overhead to collect and disseminate. The 3GPP mechanism that provides the presence service requires the network to collect presence information from presentity devices and pass that information (i.e. presence update) to watcher devices. In a cellular communication system, the delivery of presence information to the watcher devices will take a significant amount of bandwidth that might otherwise be used in real-time communication. OMA PoC specifications allow presence information to be updated whenever any change in presence occurs. Unfortunately, this approach will tend to overload network signaling and use up an unnecessary amount of network bandwidth.

One solution is to provide event filters whereby a presence information subscriber can select specific information to be received in the presence information sent. Although these prior art event filters do lower the frequency of presence updates, these filters do not discriminate between the relative importance of various presence information and therefore reduce the usefulness of the filtered presence data.

Therefore, a need exists for a method and apparatus that reduces the amount of information sent over the air. It would also be an advantage to lower the frequency of presence updates while at the same time maintaining the usefulness of the presence data.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 shows a simplified block diagram of a network, in accordance with the present invention;

FIG. 2 shows a timing diagram of communications in the network of FIG. 1;

FIG. 3 shows a flow chart of a method, in accordance with the present invention; and

FIG. 4 shows an expanded portion of FIG. 3.

### DETAILED DESCRIPTION OF THE PREFERRED EMBODIMENT

The present invention provides a method and apparatus that reduces the amount of presence information sent over the air in a Push-To-Talk over cellular (PoC) or other wireless communication network that provides presence and availability services. The present invention also potentially lowers the frequency of presence updates while at the same time maintaining the usefulness of the presence data. The present invention finds particular applicability to 3GPP and 3GPP2 communication networks. However, those of ordinary skill in the art realize that communication networks may operate in accordance with any wireless telecommunication system, such as but not limited to a Code Division Multiple Access (CDMA) communication system, a Global System for Mobile Communications (GSM) communication system, a Universal Mobile Telecommunication System (UMTS) communication system, a Time Division Multiple Access (TDMA) communication system, a Frequency Division Multiple Access (FDMA) communication system, or an Orthogonal Frequency Division Multiple Access (OFDM) communication system.

Current presence service requires the infrastructure to collect presence information from presentities and to pass that information (i.e., presence updates) to the watchers. In a wireless system, the delivery of presence information to the watchers will take up precious bandwidth over the air. The present invention minimizes the amount of presence update information sent over the air and at the same time maintaining the usefulness of the presence data (since the presence data is time sensitive).

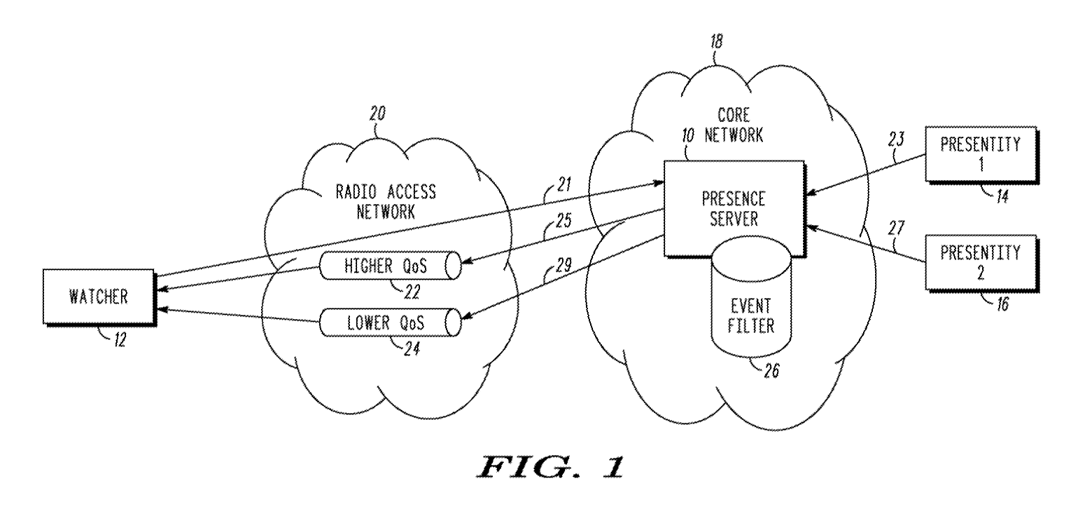

The present invention may be more fully described with reference to FIG. 1, which is a block diagram of a wireless communication network in accordance with an embodiment of the present invention. The communication network includes a presence server operable in a 3GPP or 3GPP2 communication system, i.e. Radio Access Network 20, which provides at least packet data digital wireless communication. The presence server can be independently used, although it may be bundled with Push-To-Talk over cellular (PoC) communication capabilities. A Core Network 18 is also provided that further connects to a public network, such as a Public Land Mobile Network (PLMN) or a Public Switched Telephone Network (PSTN) as is known in the art, thereby providing a circuit switched network for a communication session involving any one or more communication devices. The core network 18 further connects to an Internet Protocol (IP) network as is known in the art, thereby providing a packet switched network for a communication session involving any one or more communication devices. The core network also includes a location database and directory to keep track of locations and addresses of the various communication devices, as is known in the art.

User equipment, such as a mobile radiotelephone, personal digital assistant, computer, or any other wireless communication device is provided with Presence and Availability capabilities, and is designated as a Watcher 12. A watcher looks for the presence information of other presence and availability capable devices. Watchers can obtain presence information through a presence server by fetching presence information, periodically polling for presence information; or subscribing to the presence information of another. Watchers may also be presentities, such as would be the case when mobile devices are interested in each other's presence.

Presentities 14, 16 are also provided with presence and availability capabilities, wherein the Watcher is able to use a Push-To-Talk (PTT) or other communication feature to communicate with either or both Presentities 14, 16. Presentities can be mobile devices (i.e. user equipment) or a host (i.e. a server, web page, or device or application at a particular address such as “user domain”) and can be a running application or a user agent. A presentity has presence and availability information associated with it, such as its location and current state. The current state of a presentity may be represented by, for example, states such as: “online”; “offline”; “busy”; “idle”; “reading”; “locked”; “IM available”; “IM unavailable”; “PoC available”; and “PoC unavailable”, but being present does not necessarily mean that the presentity is available.

The presence server 10 provides presence updates of the presentities 14, 16 to the watcher 12. These updates take the form of status events, or more particularly a change of status event, such as a presentity changing its status from “offline” to “online”. The presence server can obtain updates by periodically polling presentities for their status, or more typically presentities can report any change of status, such as when a presentity powers-on, thereby reducing communication overhead. Presence server 10 includes a controller, such as one or more microprocessors, microcontrollers, digital signal processors (DSPs), combinations thereof or such other devices known to those having ordinary skill in the art, and a memory such as random access memory (RAM), dynamic random access memory (DRAM), and/or read only memory (ROM) or equivalents thereof, that store data and programs, such as an event filter application, that may be executed by the controller to perform all functions necessary to operate in the presence and availability communication system, in accordance with the present invention. The presence server 10 can also include a receiver and transmitter for communication over the radio access network 20 to a particular watcher 12.

The radio access network 20 provides communications services to a watcher (and presentity as needed) via a respective air interface that includes a forward link and a reverse link. Each forward link includes a paging channel, at least one forward link control channel, and at least one forward link traffic channel. Each reverse link includes a reverse link access channel, at least one reverse link control channel, and at least one reverse link traffic channel. Typically, the presence server 10 obtains a status of a presentity over the Internet through an internet protocol, and provides this status to the watcher 12 over an available wireless radio access network 20. However, it should be realized that the Watcher 12 could be directly attached to the Core Network 18, and/or the Presentity could connect to the presence server 10 through a radio access network 20. FIG. 1 is only shown as a typical example of the network connections.

Of course, a particular watcher 12 will not be interested in receiving status updates of every presentity available on the network. Therefore, to reduce communication overhead, an event filter 26 is provided. A first function of the event filter is to obtain a “buddy list”, “subscribed list”, or “talk group member list” from the watcher 12. Typically, this list of watcher-desired presentities corresponds to an address book of the watcher. The presence server 10 keeps this list in memory and maps the list to a list of identifiers (mobile IDs, IP addresses, etc.) that are uniquely associated with the presentities that are members of the list. The list can also be stored in a different server that the presence server has access to when needed, e.g., in the OMA, where all the lists are stored in a list server. Using a tailored list limits the presence server to only send status updates for those presentities on the particular watcher's list.

The watcher can be a mobile radiotelephone in a typical example. The watcher can include a user interface coupled to a processor, such as one or more microprocessors, microcontrollers, digital signal processors (DSPs), combinations thereof or such other devices known to those having ordinary skill in the art. The watcher further includes at least one memory device associated with processor, such as random access memory (RAM), dynamic random access memory (DRAM), and/or read only memory (ROM) or equivalents thereof, that store data and programs that may be executed by the processor and that allow the watcher to perform all functions necessary to operate in a presence and availability communication system.

The user interface provides a user of the mobile device with the capability of interacting therewith, including inputting instructions into the device. In one embodiment of the present invention, the user interface includes a display screen and a keypad that includes multiple keys, including a Push-to-Talk (PTT) key, that may be used by a user of the device to input instructions. In a preferred embodiment of the present invention, the display screen provides a list of presentities that the watcher desires to monitor for changes of status and availability for a PTT or other type of communication session. For example, a user can select a presentity on the list and press the PTT key to initiate a PTT session with the selected presentity. The list can take the form of an address or phone book with a list of presentities, preferably wherein a status icon can be associated with each entity on the list showing their current status. This list can be downloaded to the event filter 26 of the presence server 10 for use in monitoring the status only those presentities on the list for the watcher.

The user interface of the watcher can also be used to define only those status events of particular interest to the watcher. For example, the watcher may only be interested in receiving a notification from the presence server that a particular presentity has a status of “PoC available” or “offline”, for example. In addition, different desired status event notifications can be defined for different presentities. These desired status event notifications can also be downloaded to the event filter 26 of the presence server 10 along with the list of presentities.

Therefore, another function of the event filter 26 is to filter all status information from a presentity against the list and associated desired status event notifications from the watcher. In this way, the presence server only reports the desired status from a desired presentity to the watcher, further reducing communication overhead on the network. More preferably, the presence server only reports a change in desired status from a desired presentity to the watcher, even further reducing communication overhead on the network. To further reduce communication overhead on especially wireless networks, the presence server typically applies a throttling mechanism when sending notifications of changes in status to watchers. The throttling mechanism prevents the presence server from sending more than one notification of changes to the same watcher during a pre-set time interval. The change of status can then be indicated on the user interface of the watcher, with a change of icon and additional another indication such as an audio or visual cue.

A novel aspect of the present invention is assigning priorities to each of the desired status event notifications associated with each presentity. In particular, the priorities are indicated in fields of a filter document for the event filter. In this case, the presence server 10 receives the defined priorities of particular status events from the watcher. The presence server transmits status event notifications to the watcher. The event filter is operable to map the priorities to a list of status events. The controller is coupled to the receiver, transmitter and event filter. The controller responds to a change of status event of a presentity of the presence and availability communication network by comparing the status event of the equipment to the list of status events of the event filter. If the comparable status event has an associated higher priority, the controller directs the transmitter to send a notification of the change of status event with substantially no delay to the watcher. However, if the comparable status event has an associated lower priority, the controller directs the event filter to filter the status event, and the transmitter to buffer the status event for the next transmission opportunity according to the current server throttling rules.

Typically, for low priority events the presence server sends a desired notification of the change of status event in a normal manner at predetermined periodic time intervals. However, a watcher can also note those status events of no interest to the watcher. In this case, the presence server receives those status events from the watcher where notification is not desired, and wherein the event filter filters out those lower priority status events where notification is not desired, thereby further reducing communication overhead.

Priority of status events can be defined in different ways. In one embodiment, priority is defined by the watcher by associating a maximum delay with particular status events. Maximum delay is the longest rate (e.g. seconds) that the watcher is willing to have notifications delayed for the content associated with the filter. High priority events can be assigned a default zero delay (i.e. send notification immediately) and low priority events can be assigned some significant maximum delay (i.e. send in next normal time period or at most before the maximum desired delay). The controller treats those events with substantially no maximum delay as higher priority events and those events with more than zero maximum delay as lower priority events, and wherein the event filter filters the status event and the transmitter sends the status event notification before the maximum delay expires. Optionally, a minimum delay can be specified in the priority. In this case the maximum delay will be greater than or equal to the minimum delay value. Alternatively, priority can be explicitly defined, such as a high priority or low priority flag in a field of the event filter document.

In a preferred embodiment, higher priority event notifications can also be sent in higher quality communication pipes to the watcher. Specifically, the presence server controller can determine a Quality of Service (QoS) value for available channels in the radio access network 20, wherein the notification for higher priority status events is sent on a channel 22 with a higher QoS and the notification for lower priority status events are sent on a channel 24 with a lower QoS.

More preferably, channel resource management is considered in sending status event notifications. In particular, for lower priority event notifications the presence server controller establishes channel usage. If a channel is being used, the notification is transmitted between normal communication traffic packets, since unused spaces invariably occur between traffic packets. Alternatively, if a channel is not being used, the capacity of the network is used to decide whether to transmit the notification on the channel.

In another technique for reducing presence server communication overhead, the controller can add a timer parameter to a notification packet for lower priority events. This timer parameter can be defined by the watcher or presence server. If the notification packet is not transmitted before the timer expires then the notification packet is discarded by the controller. In addition, for lower priority events, if the controller determines that a packet queue of the server is full then a notification packet is discarded by the controller. In this case, a last-in first-out (LIFO) technique can be used discarding the oldest packets. Thus the periodic updates would be discarded when there is high traffic load and would always be non-interfering with other traffic for the user.

Advantageously, the present invention will enhance the user experience of the presence service and at the same time will keep the amount of presence information sent over the air small. This invention will potentially introduce modifications to signaling and message formats, such as OMA PoC, for example, and will include new information handling rules and procedures at the presence server in the network. By enabling the watcher to specify the precise presence event to watch, the information needed to be passed over the air is reduced. At the same time, higher priority presence updates are able to be sent immediately, enhancing the user experience without overloading the air link.

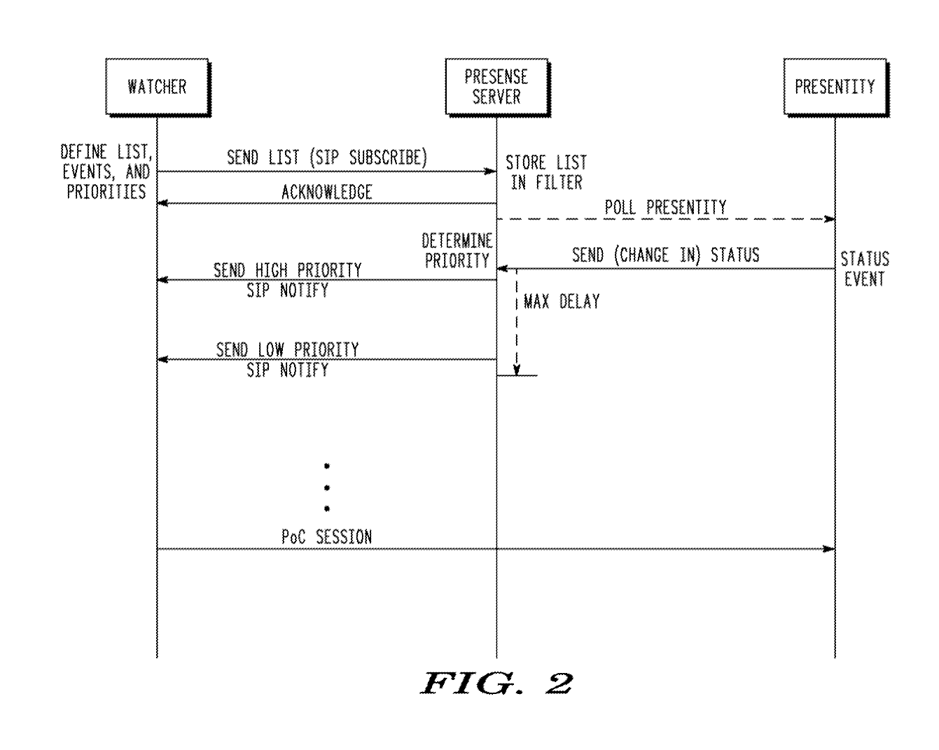

Referring now to FIGS. 1 and 2, a timing diagram is shown representing the operation of the network of FIG. 1. The Watcher 12 first defines the subscriber list of presentities, events desired for notification, and priorities for those events. This list is then sent 21 to the Presence server 10 for inclusion in the event filter 26. Specifically, the watcher signals to the presence server for presence subscription (e.g., via a SIP SUBSCRIBE), and specifies a list of high priority events that needs immediate notification services. The presence server 10 stores the subscription, event list, and priorities for the watcher and acknowledges the watcher.

The presence server can optionally poll presentities on the list for their status, or preferably can wait for the presentity to notify the presence server of its status. The presentity can periodically send its status or can just send its status when there is a change therein. If status is sent periodically, the presence serve can then note if the status is the same, and ignore it, or note if there is a change in status and filter it. In either case, the presence server obtains any change in status events.

If the event filter notes that a status event change is a higher priority event, such as from 23 presentity 1 for example, 1, the presence server makes an immediate notification 25 of the high priority event (e.g., via a SIP NOTIFY) to the watcher 12. Different mechanism can be employed to indicate the priority of the notification. In one embodiment, the server can use TOS bits in the IP header to tell RAN 20 that this is a high priority NOTIFY. In another embodiment, two different ports 22, 24 at the RAN can be used for receiving high priority and low priority notifications separately.

However, when an event outside of the high priority event list (i.e. lower priority) happens, such as from 27 presentity 2 for example, the presence server 10 will record the event, possibly holding up the notification 29 until a pre-scheduled delivery cycle, or up to a specified maximum delay time, whichever is shorter.

In a preferred embodiment, a higher QoS pipe 22 is used in radio access network (RAN) for passing the high priority event to the watcher. If necessary, the RAN will immediately allocate all needed resources such as PDP/PPP context specifically for the delivery of this high priority notification.

Any lower priority event is delivered using a lower QoS pipe 24 in the RAN to the watcher. Additionally, the RAN can determine if there is an active PDP/PPP context and send the notification packet over that PDP/PPP context. If there is no active context, and RAN occupancy is over a threshold, the presence server buffers the packet with a “time-to-live” parameter and waits until there is an active context. In this case, the packets would share the same packet resource that other packet data traffic uses, but on a “space available” basis.

Afterwards, the watcher can choose to initiate a PoC or other type of communication session, using techniques known in the art.

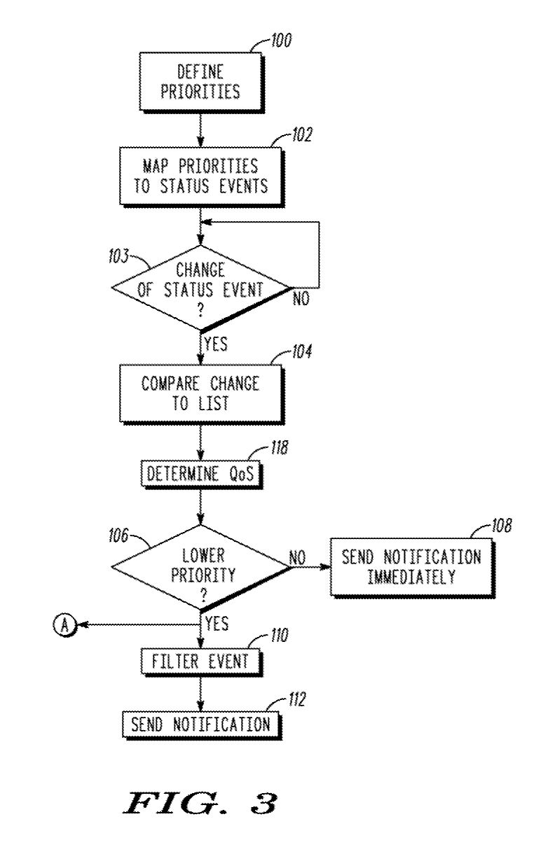

Referring to FIG. 3, a logic flow diagram is provided that illustrates a method of facilitating a presence and availability session in accordance with various embodiments of the present invention by reducing the amount of presence server communications in a presence and availability communication network.

The method includes a first step 100 of defining priorities of particular status events. For example, priority can be defined by associating a maximum delay with particular status events, wherein those events with substantially no maximum delay are higher priority events and those events with more than zero maximum delay are lower priority events. This step can include defining those status events where notification is not desired, which can be indicated by no or low priority.

A next step 102 includes mapping the priorities to a list of status events in an event filter.

A next step 104 includes, in response to a change of status event 103 of equipment capable of presence and availability communication, comparing the status event of the equipment to the list of status events of the event filter.

A next step 106 includes determining if the watcher considers the status event as a higher or lower priority.

If the comparable status event has an associated higher priority, a next step 108 includes sending a notification of the change of status event with substantially no delay, and If the comparable status notification event has an associated lower priority, a next step 110 includes filtering the status event in the event filter.

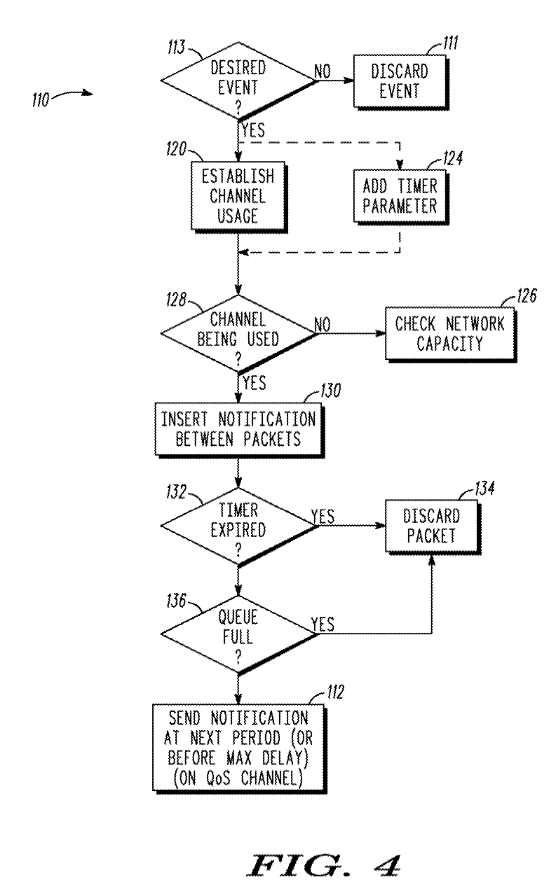

Referring to FIG. 4, an expanded methodology for filtering 110 and sending 112 low priority events is shown. If the watcher does not want to receive any notification 113 for that particular event (i.e. undesired event), then a next step 111 includes filtering out (i.e. discarding) the event. Otherwise, a notification is sent out 112 before a maximum delay expires or at the next schedule predetermined periodic time interval 116, whichever is less.

Preferably, a further step 118 is included for determining a Quality of Service (QoS) value for available channels in the network, wherein the notification 108 for higher priority status events is sent on a channel with a higher QoS and the notification for lower priority status events are sent on a channel with a lower QoS.

More preferably, for lower priority event notifications, a further step 120 is included for establishing channel usage, wherein if a channel is being used 128, the notification is sent between 130 normal communication traffic, and if a channel is not being used, the capacity of the network is used 126 to decide whether to send the notification on the channel.

Even more preferably, for lower priority event notifications, a further step 124 is included for adding a timer parameter to a notification packet for lower priority events, wherein if the notification packet is not sent before the timer expires 132 then the notification packet is discarded 134. Alternatively, if a packet queue of the server is full 136 then a notification packet is discarded 134.

Although the example presented above utilizes only high and low priorities for status events, the present invention also envisions the use of many different priority levels (e.g. low, medium, high), with different actions available for each to improve bandwidth utilization for a presence server. In this way, watchers are able to specify one or more conditions upon which presence notifications are generated and sent to them. These conditions include at least: specific changes in presence status of a presentity or list of presentities; and time constraint conditions, such as buffering or throttling mechanisms, such as those described herein.

In particular, the present invention provides an event notification throttling mechanism for the watcher to control the rate of notifications, wherein a watcher subscribing to presence information may request event notification throttling. A watcher requesting event notification throttling, and the presence server, shall support event filtering, as described herein. In practice, watcher-specified event throttling is supported in an XML Schema in Presence Information Data Format (PIDF), as is known in the art, by the OMA-specific extensions to an event filter format, such as an XML Configuration Access Protocol (XCAP), also known in the art. The throttle element implementing priority shall be an optional child element to the filter element.

The throttle element can have the following optional attributes: a minimum delay being the shortest rate, in seconds, that the watcher is willing to receive notifications for the content associated with the filter, with the default value being zero, and maximum delay being the longest rate, in seconds, that the watcher is willing to have notifications delayed for the content associated with the filter, wherein the maximum delay shall be greater than or equal to the minimum delay value, with the default value being zero.

If the presence server supports event notification filtering as described herein, understands the throttle extension, and the throttle element is present, then the presence server should send event notifications at a rate according to the minimum delay and maximum delay attribute values.

In operation, the priority element shall be an optional child element to the filter element. The priority element describes a relative priority for the content associated with the filter, and has at least two enumerated values: “high” where the watcher considers the content high priority, and “low” where the watcher considers the content low priority. Optionally, a “normal” value can be used where the watcher considers the content normal priority, which is the default value.

Preferably, presence server behavior is further defined for the various values of the priority element, as described herein. One example implementation is that the presence server may send event notifications with differentiated QoS, as described above. In addition, in all cases the watchers and presentities can be represented by various presence proxies and agents, as are known in the art While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. A method for throttling communication messages in a communication network, the method comprising the steps of:
defining priorities of particular status events;
mapping the priorities to a list of status events in an event filter; and
in response to a change of status event of equipment, comparing the status event of the equipment to the list of status events of the event filter, wherein
if the comparable status event has an associated higher priority, sending a notification of the change of status event with substantially no delay, and
if the comparable status notification event has an associated lower priority, filtering the status event in the event filter.

2. The method of claim 1, wherein the defining step includes defining those status events where notification is not desired, and wherein the comparing step includes filtering out those lower priority status events where notification is not desired.

3. The method of claim 1, wherein the priorities are indicated in fields of a filter document for the event filter.

4. The method of claim 1, wherein priority is defined by associating a maximum delay with particular status events, wherein those events with substantially no maximum delay are higher priority events and those events with more than zero maximum delay are lower priority events, and wherein the event filter filters and sends the status event notification before the maximum delay expires.

5. The method of claim 1, further comprising the step of determining a Quality of Service (QoS) value for available channels in the network, wherein the notification for higher priority status events is sent on a channel with a higher QoS and the notification for lower priority status events are sent on a channel with a lower QoS.

6. The method of claim 1, wherein the notifications for filtered lower priority events are sent at predetermined periodic time intervals.

7. The method of claim 1, wherein for lower priority event notifications further comprising the step of establishing channel usage, wherein
if a channel is being used, the notification is sent between normal communication traffic, and
if a channel is not being used, the capacity of the network is used to decide whether to send the notification on the channel.

8. The method of claim 1, further comprising the step of adding a timer parameter to a notification packet for lower priority events, wherein if the notification packet is not sent before the timer expires then the notification packet is discarded.

9. The method of claim 1, wherein for lower priority events, if a packet queue of the server is full then a notification packet is discarded.

10. In a communication network, a server with throttled communications, the server comprising:
a receiver that receives defined priorities of particular status events from a watcher;
a transmitter to transmit status event notifications to the watcher;
an event filter operable to map the priorities to a list of status events; and
a controller coupled to the receiver, transmitter and event filter, the controller responds to a change of status event of a presentity of the communication network by comparing the status event of the equipment to the list of status events of the event filter, wherein
if the comparable status event has an associated higher priority, the controller directs the transmitter to send a notification of the change of status event with substantially no delay to the watcher, and
if the comparable status event has an associated lower priority, the controller directs the event filter to filter the status event.

11. The server of claim 10, wherein the receiver also receives those status events from the watcher where notification is not desired, and wherein the event filter filters out those lower priority status events where notification is not desired.

12. The server of claim 10, wherein the priorities are indicated in fields of a filter document for the event filter.

13. The server of claim 10, wherein priority is defined by the watcher which associates a maximum delay with particular status events, wherein the controller treats those events with substantially no maximum delay as higher priority events and those events with more than zero maximum delay as lower priority events, and wherein the event filter filters the status event and the transmitter sends the status event notification before the maximum delay expires.

14. The server of claim 10, wherein the controller determines a Quality of Service (QoS) value for available channels in the network, wherein the notification for higher priority status events is sent on a channel with a higher QoS and the notification for lower priority status events are sent on a channel with a lower QoS.

15. The server of claim 10, wherein the notifications for filtered lower priority events are sent by the transmitter at predetermined periodic time intervals.

16. The server of claim 10, wherein for lower priority event notifications the controller establishes channel usage, wherein
if a channel is being used, the notification is transmitted between normal communication traffic, and
if a channel is not being used, the capacity of the network is used to decide whether to transmit the notification on the channel.

17. The server of claim 10, wherein the controller adds a timer parameter to a notification packet for lower priority events, wherein if the notification packet is not transmitted before the timer expires then the notification packet is discarded by the controller.

18. The server of claim 10, wherein for lower priority events, if the controller determines that a packet queue of the server is full then a notification packet is discarded by the controller.
